(19) United States
(12) Patent Application Publication
(10) Pub. No.: US 2024/0404180 A1
(43) Pub. Date: Dec. 5, 2024

(54) INFORMATION PROCESSING DEVICE, INFORMATION PROCESSING METHOD, AND PROGRAM

(71) Applicant: SONY GROUP CORPORATION, TOKYO (JP)

(72) Inventors: DAITA KOBAYASHI, TOKYO (JP); HIROTAKE ICHIKAWA, TOKYO (JP); ATSUSHI ISHIHARA, TOKYO (JP); TAKUMI HAMASAKI, TOKYO (JP); YUKI MORIKUBO, TOKYO (JP)

(21) Appl. No.: 18/697,743

(22) PCT Filed: Sep. 12, 2022
(86) PCT No.: PCT/JP2022/034000

§ 371 Date: Apr. 2, 2024

(30) Foreign Application Priority Data
Oct. 13, 2021 (JP) 2021-168092

(51) Int. Cl. G06T 15/20; G06T 5/20; G06T 5/70; G06T 7/194; G06T 7/55; G06T 7/90

(52) U.S. Cl. CPC G06T 15/205; G06T 5/20; G06T 5/70; G06T 7/194; G06T 7/55; G06T 7/90; G06T 2207/10024; G06T 2207/20212

(57) ABSTRACT

Provided is an information processing device configured to acquire a color image at a first viewpoint and a depth image at a second viewpoint, and generate an output color image at a virtual viewpoint different from the first viewpoint on a basis of a result of separation processing of separating the depth image into a foreground depth image and a background depth image.

### TECHNICAL FIELD

The present technology relates to an information processing device, an information processing method, and a program.

### BACKGROUND ART

There is a function called video see through (VST) in a virtual reality (VR) device such as a head mount display (HMD) including a camera. In general, when a user wears the HMD, the user cannot see an outside scene. However, the user can see the outside scene in a state of wearing the HMD by displaying a video imaged by the camera on a display included in the HMD.

In the VST function, it is not physically possible to completely match positions of the camera and eyes of the user, and parallax constantly occurs between two viewpoints. Thus, when an image imaged by the camera is displayed on the display as it is, since a size of an object and binocular parallax are slightly different from the reality, spatial discomfort occurs. It is considered that this discomfort hinders interaction with a real object or causes VR sickness.

Therefore, it is considered to solve this problem by using a technology called “viewpoint transformation” that reproduces an outside world video viewed from the positions of the eyes of the user on the basis of an outside world video (color information) imaged by a VST camera and geometry (three-dimensional topography) information.

As a main problem of the viewpoint transformation, there is compensation of an occlusion (shielding) region is generated before and after the viewpoint transformation. The occlusion means that a background is shielded by an object in a foreground, and the occlusion region is a region in which the background cannot be seen or a depth or a color cannot be acquired by shielding the background by the object in the foreground. In order to compensate for this occlusion region, it is necessary to continuously estimate geometry information of an environment in real time (to correspond to a moving object), and display depth information and color information of a region currently invisible from a viewpoint transformation source to a viewpoint transformation destination while compensating for the depth information and the color information.

As an algorithm for estimating the geometry in real time, for example, there is a viewpoint transformation algorithm named “Passthrough+”. In this method, an environment depth is estimated with a coarse mesh of 70×70 in order to reduce a processing load of the geometry estimation, and an artifact in which the background is distorted occurs when an object such as a hand is put forward. As a measure to reduce the processing load, there is a method for continuously generating a two-dimensional depth buffer (depth information) and a color buffer (color information) viewed from the positions of the eyes of the user (Patent Document 1).

### CITATION LIST

### Patent Document

Patent Document 1: Japanese Patent Application Laid-Open No. 2016-201788

### SUMMARY OF THE INVENTION

### Problems to be Solved by the Invention

In the technology of Patent Document 1, since minimum geometry information necessary for viewpoint transformation is handled, the processing load can be greatly reduced. However, there is a problem that the occlusion region is generated in a case where the viewpoint of the user changes due to movement of a subject or the user cannot be completely covered.

The present technology has been made in view of such problems, and an object thereof is to provide an information processing device, an information processing method, and a program capable of compensating for an occlusion region generated by viewpoint transformation or a change in a viewpoint of a user.

### Solutions to Problems

In order to solve the above-described problem, a first technology is an information processing device configured to acquire a color image at a first viewpoint and a depth image at a second viewpoint, and generate an output color image at a virtual viewpoint different from the first viewpoint on a basis of a result of separation processing of separating the depth image into a foreground depth image and a background depth image.

Furthermore, a second technology is an information processing method including acquiring a color image at a first viewpoint and a depth image at a second viewpoint, and generating an output color image at a virtual viewpoint different from the first viewpoint on a basis of a result of separation processing of separating the depth image into a foreground depth image and a background depth image.

Moreover, a third technology is a program causing a computer to execute an information processing method of acquiring a color image at a first viewpoint and a depth image at a second viewpoint, and generating an output color image at a virtual viewpoint different from the first viewpoint on a basis of a result of separation processing of separating the depth image into a foreground depth image and a background depth image.

### BRIEF DESCRIPTION OF DRAWINGS

FIG. 1 is an external view of an HMD 100.

FIG. 2 is a processing block diagram of the HMD 100.

FIG. 3 is a processing block diagram of an information processing device 200 according to a first embodiment.

FIG. 4 is a flowchart illustrating processing by the information processing device 200 according to the first embodiment.

FIG. 5 is an image example of extraction of a foreground region using IR full surface light emission.

FIG. 6 is an explanatory diagram of a second method of foreground and background separation.

FIG. 7 is an explanatory diagram of compensation of an occlusion region by combination of a depth image.

FIG. 8 is an image diagram of a smoothing effect by combination of a background depth image.

FIG. 9 is a diagram illustrating an algorithm of combination processing of a background depth image for each pixel.

FIG. 10 is an explanatory diagram of a first method for determining α of α blending in combination of a depth image.

FIG. 11 is an explanatory diagram of a second method for determining α in α blending in combination of a depth image.

FIG. 12 is an explanatory diagram of deviation of depth image combination due to a self-position estimation error.

FIG. 13 is an explanatory diagram of a third method for determining α in α blending in combination of a depth image.

FIG. 14 is an explanatory diagram of foreground mask processing.

FIG. 15 is an explanatory diagram of a second method for determining α of α blending in combination of a color image.

FIG. 16 is an explanatory diagram of alignment by block matching in composition of a color image.

FIG. 17 is a processing block diagram of the information processing device 200 in which the number of color cameras 101 and the like are not limited and are generalized.

FIG. 18 is a diagram illustrating an example of a positional relationship between a background, a sensor, and a virtual viewpoint in a second embodiment.

FIG. 19 is a processing block diagram of an information processing device 200 according to the second embodiment.

FIG. 20 is a flowchart illustrating processing by the information processing device 200 according to the second embodiment.

FIG. 21 is a diagram illustrating a specific example of processing by the information processing device 200 according to the second embodiment.

FIG. 22 is a diagram illustrating a specific example of processing by the information processing device 200 according to the second embodiment.

FIG. 23 is an explanatory diagram of a modification of the present technology.

### MODE FOR CARRYING OUT THE INVENTION

Hereinafter, embodiments of the present technology will be described with reference to the drawings. Note that, the description will be made in the following order.
<1. First Embodiment>
[1-1. Configuration of HMD 100]
[1-2. Processing by Information Processing Device 200]
<2. Second Embodiment>
[2-1. Processing by Information Processing Device 200]
<3. Modifications>

### 1. First Embodiment

### [1-1. Configuration of HMD 100]

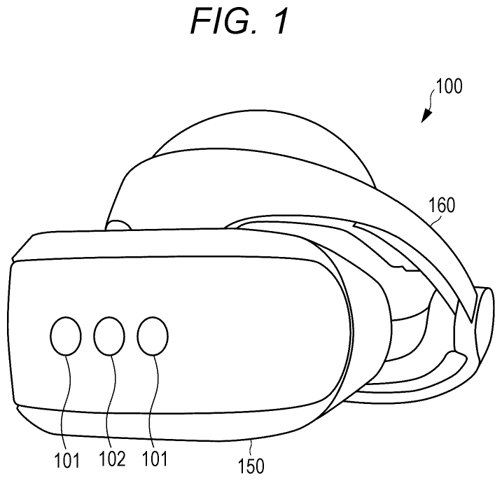

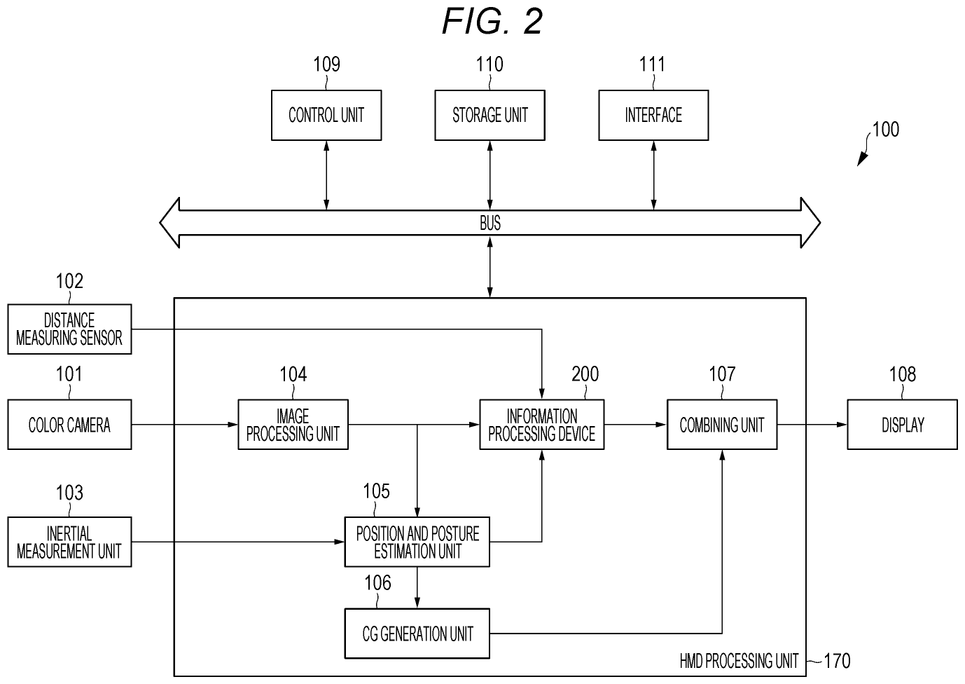

A configuration of an HMD 100 having a VST function will be described with reference to FIGS. 1 and 2. The HMD 100 includes a color camera 101, a distance measuring sensor 102, an inertial measurement unit 103, an image processing unit 104, a position and posture estimation unit 105, a CG generation unit 106, an information processing device 200, a combining unit 107, a display 108, a control unit 109, a storage unit 110, and an interface 111.

The HMD 100 is worn by a user. As illustrated in FIG. 1, the HMD 100 includes a housing 150 and a band 160. The housing 150 houses the display 108, a circuit board, a processor, a battery, an input and output port, and the like. Furthermore, the color camera 101 and the distance measuring sensor 102 facing a front direction of the user are provided in front of the housing 150.

The color camera 101 includes an imaging element, a signal processing circuit, and the like, and is a camera capable of imaging a color image and a color video of RGB (Red, Green, Blue) or a single color.

The distance measuring sensor 102 is a sensor that measures a distance to a subject and acquires depth information. The distance measuring sensor 102 may be an infrared sensor, an ultrasonic sensor, a color stereo camera, an infrared (IR) stereo camera, or the like. Furthermore, the distance measuring sensor 102 may be triangulation or the like using one IR camera and structured light. Note that, a depth is not necessarily a stereo depth as long as the depth information can be acquired, and may be a monocular depth using time of flight (ToF) or motion parallax, a monocular depth using an image plane phase difference, or the like.

The inertial measurement unit 103 is various sensors that detect sensor information for estimating a posture, an inclination, and the like of the HMD 100. The inertial measurement unit 103 is, for example, an inertial measurement unit (IMU), an acceleration sensor, an angular velocity sensor, or a gyro sensor for two or three axis directions.

The image processing unit 104 performs predetermined image processing such as analog/digital (A/D) conversion white balance adjustment processing, color correction processing, gamma correction processing, Y/C conversion processing, and auto exposure (AE) processing on image data supplied from the color camera 101. Note that, these types of image processing described here are merely examples, and it is not necessary to perform all of these types of image processing, and other types of processing may be further performed.

The position and posture estimation unit 105 estimates the position, posture, and the like of the HMD 100 on the basis of the sensor information supplied from the inertial measurement unit 103. The position and posture of the HMD 100 are estimated by the position and posture estimation unit 105, and thus, a position and a posture of the head of the user wearing the HMD 100 can also be estimated. Note that, the position and posture estimation unit 105 can also estimate the motion, inclination, and the like of the HMD 100. In the following description, the position of the head of the user wearing the HMD 100 is referred to as a self-position, and the estimation of the position of the head of the user wearing the HMD 100 by the position and posture estimation unit 105 is referred to as self-position estimation.

The information processing device 200 performs processing according to the present technology. The information processing device 200 uses, as inputs, a color image imaged by the color camera 101 and a depth image created from the depth information acquired by the distance measuring sensor 102, and generates a color image in which an occlusion region generated by viewpoint transformation or a change in a viewpoint of the user is compensated. In the following description, a color image finally output by the information processing device 200 is referred to as an output color image. The output color image is supplied from the information processing device 200 to the combining unit 107. Details of the information processing device 200 will be described later.

Note that, the information processing device 200 may be a single device, may operate in the HMD 100, or may operate in an electronic device such as a personal computer, a tablet terminal, or a smartphone connected to the HMD 100. Furthermore, the HMD 100 or the electronic device may be caused to execute a function of the information processing device 200 by a program. In a case where the information processing device 200 is implemented by the program, the program may be installed in the HMD 100 or the electronic device in advance, or may be installed by a user by being download and distributed in a storage medium or the like.

The CG generation unit 106 generates various computer graphic (CG) images to be superimposed on the output color image for augmented reality (AR) display and the like.

The combining unit 107 combines the CG image generated by the CG generation unit 106 with the output color image output from the information processing device 200 to generate an image to be displayed on the display 108.

The display 108 is a liquid crystal display, an organic electroluminescence (EL) display, or the like positioned in front of the eyes of the user when the HMD 100 is worn. The display 108 may be any display as long as the display can display the display image output from the combining unit 107. Predetermined processing is performed on the image imaged by the color camera 101, and the image is displayed on the display 108. Accordingly, VST is implemented, and thus, the user can see an outside scene in a state of wearing the HMD.

The image processing unit 104, the position and posture estimation unit 105, the CG generation unit 106, the information processing device 200, and the combining unit 107 constitute an HMD processing unit 170, and after image processing and self-position estimation are performed by the HMD processing unit 170, only an image on which viewpoint transformation is performed or an image generated by combining the image on which the viewpoint transformation is performed with the CG is displayed on the display 108.

The control unit 109 includes a central processing unit (CPU), a random access memory (RAM), a read only memory (ROM), and the like. The CPU controls the HMD 100 and the units thereof by executing various types of processing according to a program stored in the ROM and issuing commands. Note that, the information processing device 200 may be implemented in processing by the control unit 109.

The storage unit 110 is, for example, a large-capacity storage medium such as a hard disk or a flash memory. The storage unit 110 stores various applications operated in the HMD 100, various pieces of information used by the HMD 100 or the information processing device 200, and the like.

The interface 111 is an interface with an electronic device such as a personal computer or a game machine, the Internet, or the like. The interface 111 may include a wired or wireless communication interface. Furthermore, more specifically, the wired or wireless communication interface might include cellular communication such as 3TTE, Wi-Fi, Bluetooth (registered trademark), near field communication (NFC), Ethernet (registered trademark), high-definition multimedia interface (HDMI (registered trademark)), universal serial bus (USB) and the like.

Note that, the HMD processing unit 170 illustrated in FIG. 2 may operate in the HMD 100 or may operate in an electronic device such as a personal computer, a game machine, a tablet terminal, or a smartphone connected to the HMD 100. In a case where the HMD processing unit 170 operates in the electronic device, the color image imaged by the color camera 101, the depth information acquired by the distance measuring sensor 102, and the sensor information acquired by the inertial measurement unit 103 are transmitted to the electronic device via the interface 111 and a network (regardless of wired or wireless). Furthermore, the output from the combining unit 107 is transmitted to the HMD 100 via the interface 111 and the network and is displayed on the display 108.

Note that, the HMD 100 may be a wearable device such as a glasses-type without including the band 160, or may be integrated with headphones or earphones. Furthermore, the HMD 100 may be configured to support not only an integrated HMD but also an electronic device such as a smartphone or a tablet terminal by fitting the electronic device into a band-shaped attachment fixture or the like.

### [1-2. Processing by Information Processing Device 200]

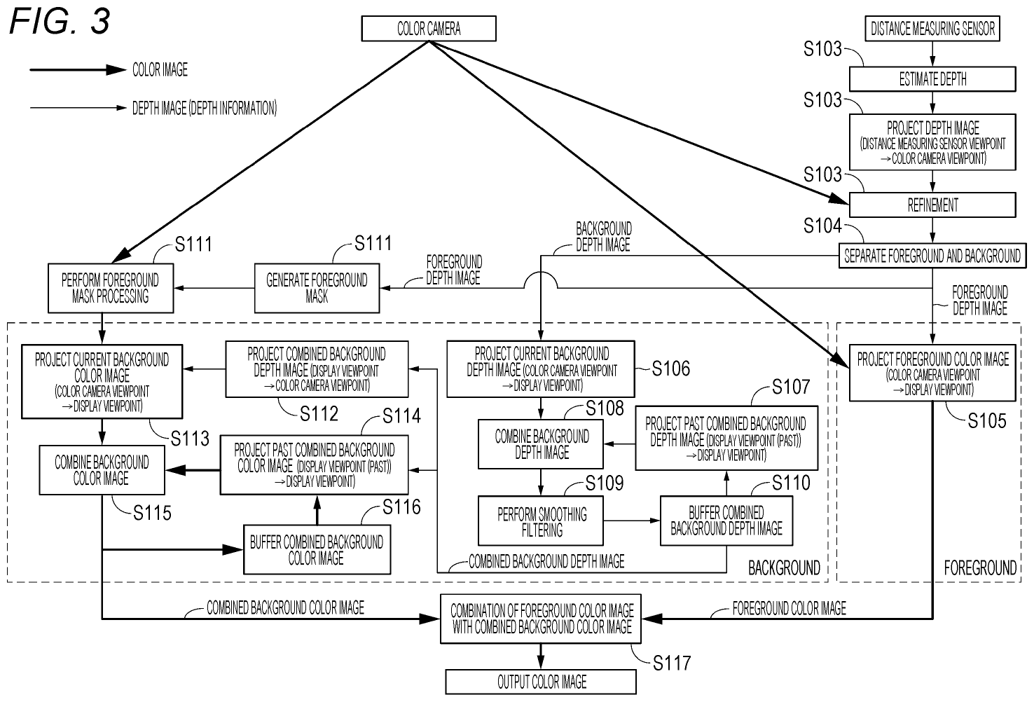

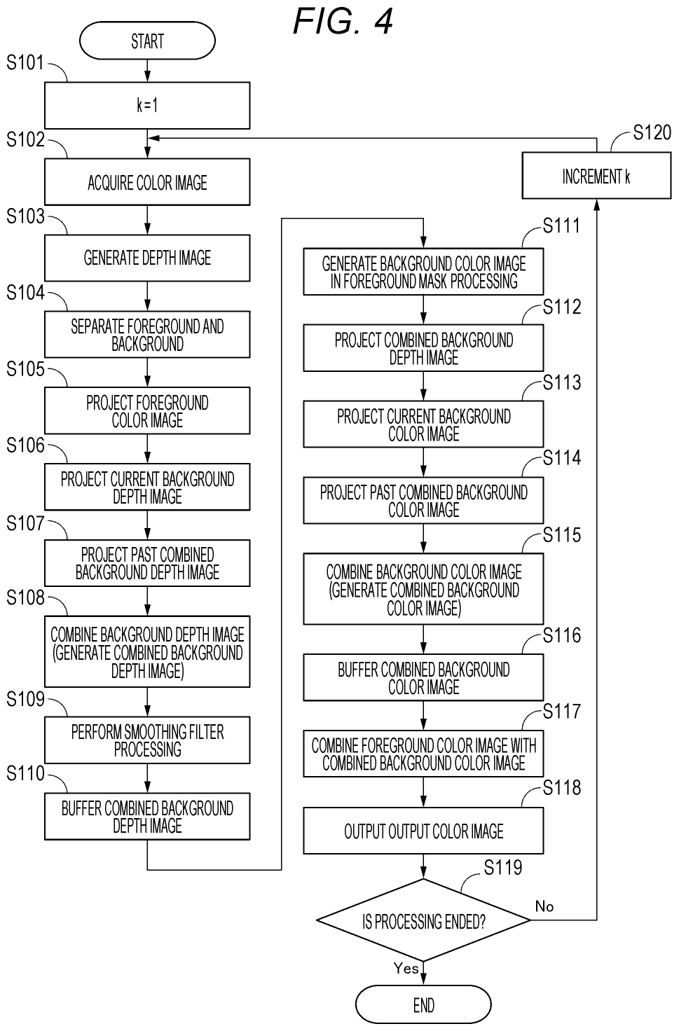

Next, processing by the information processing device 200 according to the first embodiment will be described with reference to FIGS. 3 and 4.

The information processing device 200 generates an output color image viewed from a viewpoint of the display 108 (a viewpoint of the eyes of the user) where the camera is not actually present by using the color image imaged by the color camera 101 and the depth image obtained by the distance measuring sensor 102. Note that, in the following description, the viewpoint of the color camera 101 is referred to as a color camera viewpoint, and the viewpoint of the display 108 is referred to as a display viewpoint. Furthermore, a viewpoint of the distance measuring sensor 102 is referred to as a distance measuring sensor viewpoint. The color camera viewpoint is a first viewpoint in the claims, and the distance measuring sensor viewpoint is a second viewpoint in the claims. Moreover, the display viewpoint is a virtual viewpoint according to the first embodiment. Due to the disposition of the color camera 101 and the display 108 in the HMD 100, the color camera viewpoint is positioned in front of the display viewpoint.

First, in step S101, the information processing device 200 sets a value of a frame number k indicating an image frame to be processed to 1. The value of k is an integer. In the following description, for the sake of convenience in description, processing has already been performed and k≥2. Furthermore, in the following description, a latest frame k is referred to as “current”, and a previous frame of the latest frame k, that is, a frame k−1 is referred to as “past”.

Subsequently, in step S102, a color image of the current (k) imaged by the color camera 101 is acquired.

Subsequently, in step S103, depth estimation is performed from the information obtained by the distance measuring sensor 102 to generate a depth image of the current (k). The depth image is an image of the distance measuring sensor viewpoint.

Furthermore, the depth image is projected as depth image generation. The projection of the depth image projects the depth image onto the same viewpoint as the color image, that is, the color camera viewpoint, in order to perform refinement.

Moreover, the refinement is performed as the depth image generation. A depth image obtained by one shot often contains a lot of noise. The generated depth image is refined by using edge information in the color image imaged by the color camera 101, and thus, it is possible to generate a high definition depth image with less noise along the color image. In this example, a method for obtaining an accurate depth of an edge is described, but a method for extracting only a foreground region with a luminance mask by emitting IR light to the entire visual field region by using an IR projector may be used.

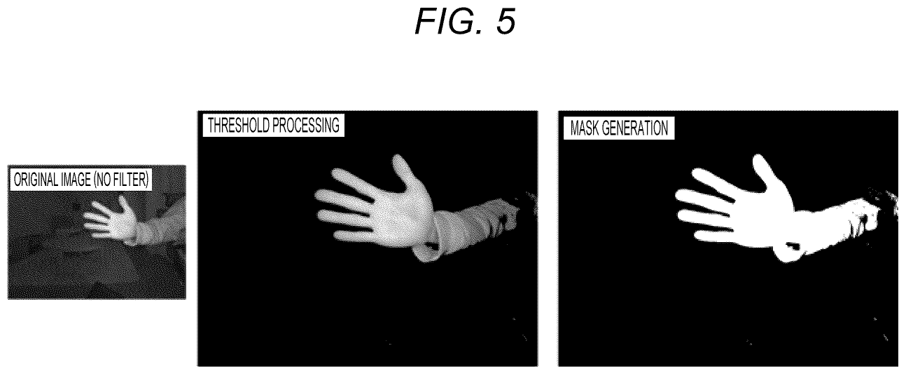

FIG. 5 illustrates an image example when the foreground region is extracted by using IR full surface light emission. A scene in which only a nearby object is reflected brightly by IR emission is imaged, and thus, the foreground region can be relatively clearly removed with a low processing load by the luminance mask.

Subsequently, in step S104, foreground and background separation processing of separating the depth image of the current (k) into a foreground depth image and a background depth image is performed. The depth image is separated into the foreground (region where occlusion is not generated since there is no object in front) and the background (region where occlusion may be generated since there may be an object in front), and thus, it is possible to prevent the occlusion region from being generated in the background even though there is a change in the foreground or the self-position. The processing on the foreground depth image is first processing in the claims, and the processing on the background depth image is second processing in the claims. The second processing is processing of combining a current background depth image projected onto the virtual viewpoint and a past background depth image projected onto the virtual viewpoint to generate a combined background depth image at the virtual viewpoint. Although described in detail later, the second processing on the background depth image has more processing steps than the first processing on the foreground depth image, and is heavy processing. The foreground and background separation processing can be performed by a plurality of methods.

A first method of the foreground and background separation is a separation method using a fixed distance (fixed threshold). A specific fixed distance is set as a threshold, and a region having a depth on a near side from the threshold is set as the foreground depth image, and a region having a depth on a far side is set as the background depth image. This is a simple method with a low processing load.

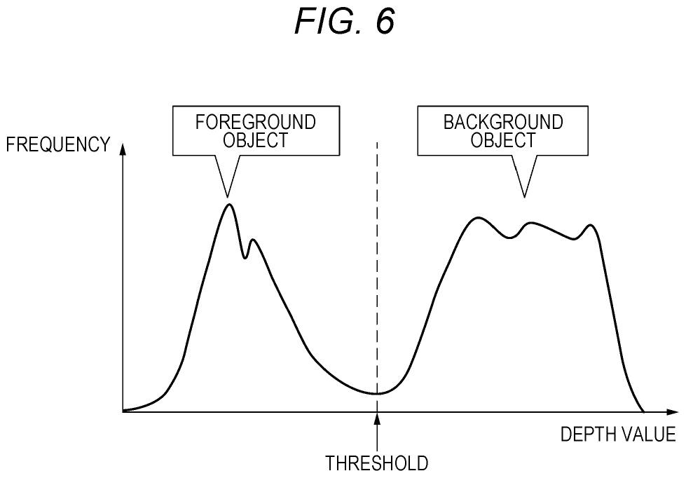

a second method of the foreground and background separation is a separation method using a dynamic distance (dynamic threshold). As illustrated in FIG. 6, a histogram is generated for the depth image at a depth and a frequency, and a depth value corresponding to a lowest frequency in a valley portion of the frequency is set as a threshold for dynamically separating the foreground and the background. In this second method, a foreground object and a background object can be separated even in a case where the motion of the foreground object or the distance of the background object is short.

In a case where the foreground and the background are present in the subject (scene), it is possible to compensate for the occlusion region of the background caused by the object present in the foreground more naturally by setting a threshold for the foreground and background separation by using such a histogram for each frame.

A third method of the foreground and background separation is a separation method using object detection and segmentation. The foreground object is extracted by a method such as the above-described method using IR full surface light emission, a method using color information in a case where the foreground object is known, or a method using machine learning, and the foreground object is separated by segmenting a two-dimensional image. Furthermore, there is also a method for performing moving object detection on a video including a plurality of color images or depth images and separating the detected moving object as the foreground and a still object as the background.

The description returns to the flowchart. Subsequently, in step S105, the color image of the current (k) in the foreground is projected. The projection of the color image in the foreground is processing of projecting the color image onto the display viewpoint (virtual viewpoint) desired to be finally displayed, by using, as inputs, the color image and the foreground depth image of the same viewpoint (color camera viewpoint). Since the color image does not have depth information (three-dimensional information), the color image needs to be projected together with the depth image of the same viewpoint (color camera viewpoint). The depth image of the color camera viewpoint has been generated in step S103. Since it is difficult for the foreground to have the occlusion region, a correct foreground color image can be generated only by projecting the color image from the color camera viewpoint onto the display viewpoint.

Subsequently, in step S106, the background depth image of the current (k) is projected. The projection of the background depth image is processing of projecting the background depth image onto any viewpoint plane. This projection is processing in which occlusion by viewpoint transformation may be generated similarly to the projection of the color image.

In the projection of the background depth image of the current (k) in step S106, the background depth image is projected from the color camera viewpoint onto the display viewpoint. Therefore, viewpoints of the background depth image of the current (k) and a background depth image of the past (k−1) accumulated by buffering are matched with each other at the display viewpoint, and the background depth images can be combined.

Furthermore, in step S107, the combined background depth image of the past (k−1) is projected. This combined background depth image is generated in the processing in step S108 in the past (k−1), and is temporarily stored by buffering in step S110.

In the projection of the combined background depth image of the past (k−1), a combined background depth image of a display viewpoint of the past (k−1) accumulated by buffering is projected onto a current (k) display viewpoint. Therefore, viewpoints of the combined background depth image of the past (k−1) and the background depth image of the current (k) accumulated by buffering are matched with each other at the display viewpoint, and the background depth images can be combined.

Subsequently, in step S108, the projected background depth image of the current (k) and the projected combined background depth image of the past (k−1) are combined, and the combined background depth image of the current (k) is generated. The background depth image of the current (k) of which the viewpoint is matched with the display viewpoint and the background depth image of the past (k−1) accumulated by buffering are combined, and occlusion compensation, depth smoothing, and background depth change tracking are performed.

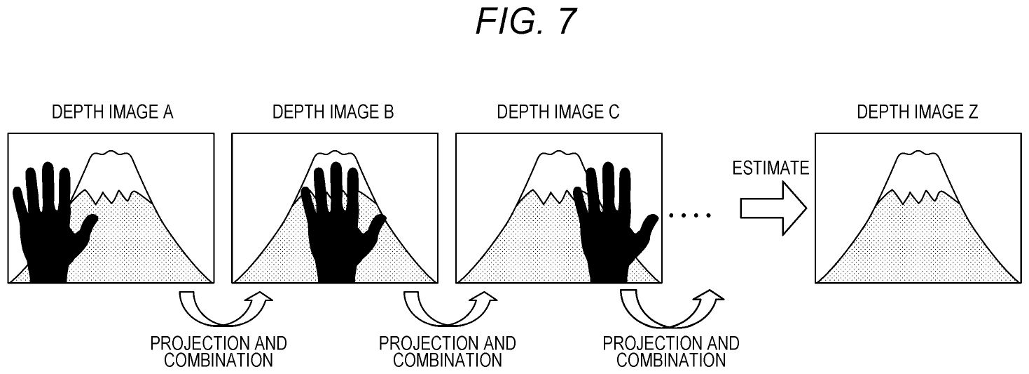

Here, the compensation for the occlusion region by the combination of the background depth image will be described with reference to FIG. 7. A depth image A, a depth image B, a depth image C, . . . , and a depth image Z are depth images of different frames and become old in the order of the depth image Z, the depth image C, the depth image B, and the depth image A (the depth image A is the oldest). Each depth image is a depth image in a state where an object region (an object is, for example, a hand) present in the foreground is filled in black and is removed (color information is set to 0), and positions of the object region are different in the depth images. These depth images are sequentially combined, and thus, the depth is estimated as long as a region in which occlusion is generated as viewed in each frame is also a region in which depth information is present in some past frame. Accordingly, it is possible to generate a depth image without occlusion as illustrated in the depth image Z.

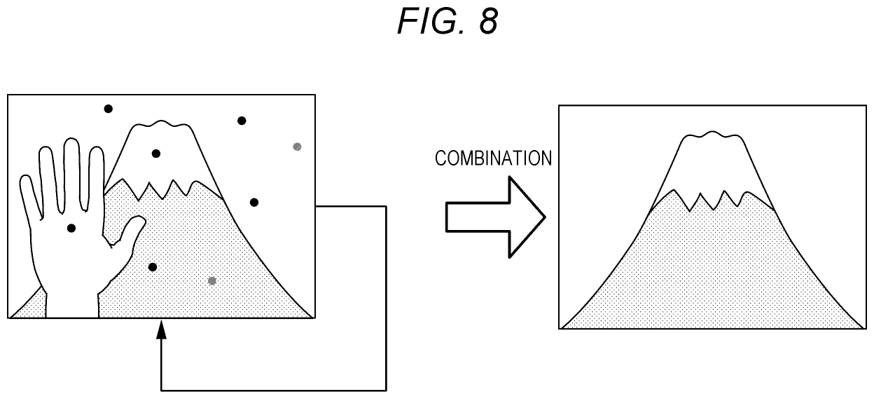

FIG. 8 is an image diagram of a smoothing effect by the combination of the background depth image. Although a depth image of one shot often contains noise, pixel values are averaged by repeatedly performing combination with a depth image obtained in the past, and it is possible to reduce prominent noise. As a result, it is possible to generate a high-quality depth image with less noise.

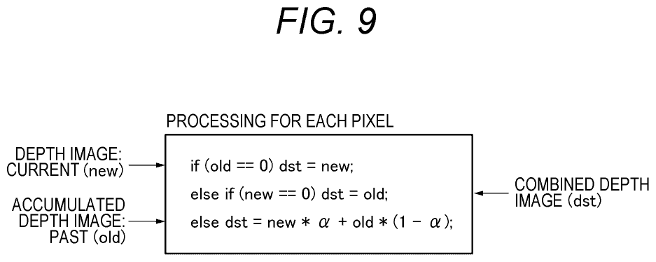

FIG. 9 illustrates an algorithm of combination processing of the background depth image for each pixel. As long as a pixel value of one of two depth images (in FIG. 9, the current (new) and the past (old)) to be combined is 0, a depth value of the other depth image is used as a depth value of the output as it is. With this processing, even though the depth value cannot be obtained due to occlusion or the like, the depth value can be filled as long as the depth value of the pixel is known in either the past or the current (occlusion compensation effect).

Furthermore, in a case where the depth information is present in both of the two depth images to be combined, a depth smoothing effect can be expected by performing α blending. As long as α is large, a proportion of the depth image of the latest frame in the combination increases, and responsiveness (high-speed performance) to the change in the background depth increases.

On the other hand, when α is decreased, the responsiveness is lowered, but since a ratio of the accumulation depth from the past frame is increased, a smoother and stable depth can be obtained. α is adaptively determined depending on the subject, and thus, it is possible to generate a depth image in which an artifact is less likely to occur. α can be determined by a plurality of methods.

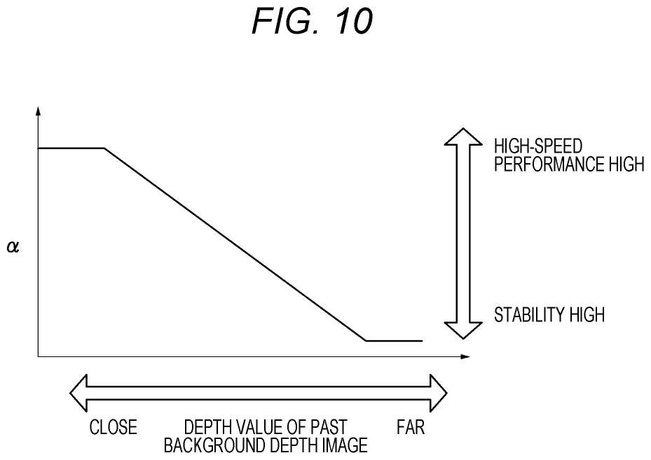

As illustrated in FIG. 10, a first method for determining α is a method for determining α in proportional to the depth value in the past background depth image. α is determined in proportion to the depth value. Accordingly, the depth at a long distance has a strong smoothing effect, and the depth at a short distance follows fluctuation of the depth at a high speed. In a case where the subject is at a long distance, the parallax of the camera is small before and after the viewpoint transformation, and even though the depth is slightly different from the actual depth, the viewpoint transformation is not greatly influenced. Furthermore, the subject at a short distance does not move at a high speed as viewed in a screen space. Therefore, it is desirable to apply a certain degree of strong smoothing. On the other hand, in the case of a short-distance subject (for example, a hand), since the subject moves at a high speed, it is preferable to prioritize high-speed followability over the smoothing effect.

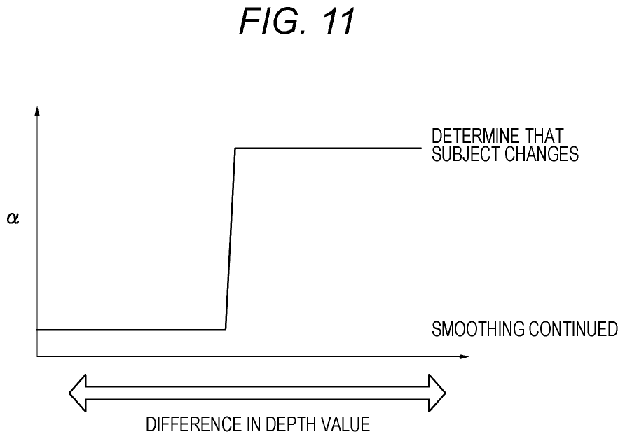

As illustrated in FIG. 11, a second method for determining α is a method based on a difference between depth values of two depth images to be combined. In a case where a difference between the background depth image of the latest frame and the background depth image accumulated from the past is equal to or more than a predetermined amount, it is determined that the depth value of the pixel changes due to the movement of the subject instead of noise due to depth estimation, and a is extremely increased not to perform depth merging with the past frame. Therefore, it is possible to reduce an artifact in which the depth of the background and the depth of the foreground are mixed and the edge of the object is blunted.

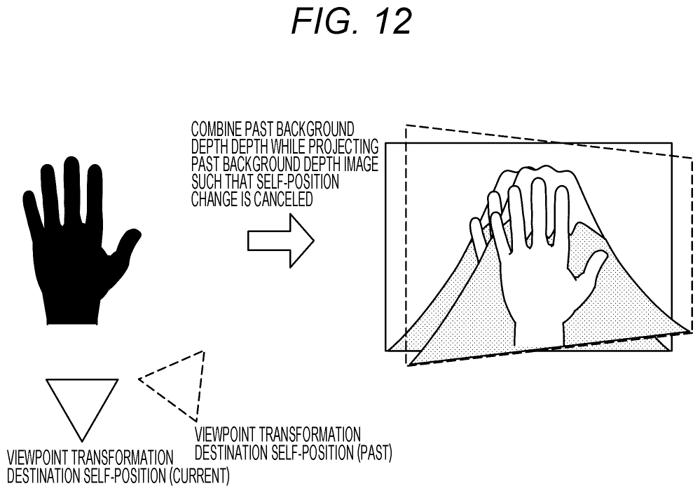

A third method for determining α is a method based on a self-position change amount of the user wearing the HMD 100. As described above, in the projection of the background depth image of the past (k−1) in step S107, the projection of the current (k) frame from the display viewpoint one frame before (k−1) to the display viewpoint is performed for each frame. Therefore, the depth image is combined while compensating for the self-position change. However, as illustrated in FIG. 12, there is a problem that a projection error is likely to occur between frames in which the self-positions are greatly changed (particularly, a rotation component).

Furthermore, while the user wearing the HMD 100 is greatly shaking their head, there is a possibility that estimation accuracy of the depth decreases (for example, a decrease in accuracy of stereo matching due to motion blur of an image in a depth estimation method using stereo matching using image recognition). Therefore, it is considered that α is changed in proportion to a self-position difference (rotation component) from the previous frame (in a case where the self-position difference is large, α is increased and the current frame is used more). When the quaternion of the rotation component of the self-position change is [Δx·Δy·Δz·Δw], the magnitude of a rotation angle can be expressed by the following Equation [1].

Δθ=2 cos−1·Δw [Equation 1]

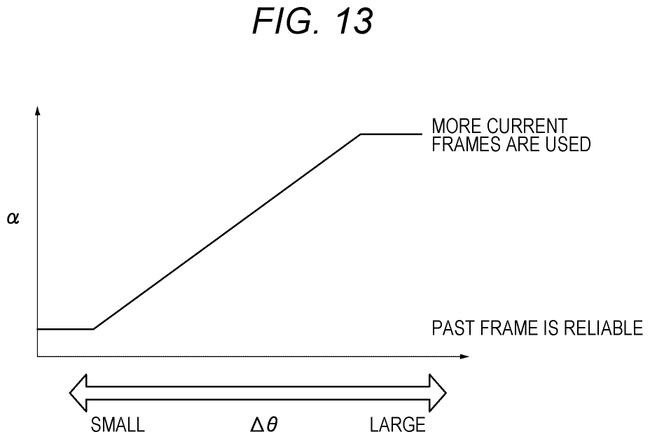

The influence of the projection error can be minimized by varying α depending on the magnitude of Δθ. FIG. 13 illustrates an image of α determination based on the self-position change amount.

A fourth method for determining α is a method based on an edge of the depth. In a case where pixels of different subjects are combined by the combination of the depth images, an edge portion of the subject is likely to cause an artifact. Therefore, the edge of the depth is determined for the pixel. The edge determination can be performed, for example, by confirming a difference in depth between a pixel to be determined and a neighboring pixel thereof. In a case where the pixel is the edge of the depth, α is determined to 0 or 1 not to mix the depths too positively. On the other hand, in a case where the pixel is not the edge of the depth (flat portion or the like), α may be determined to a value that actively mixes the depths in order to maximize the smoothing effect of the depth.

The description returns to FIGS. 3 and 4. Subsequently, in step S109, smoothing filtering processing is performed on the combined background depth image of the current (k) generated in step S108. In a case where the background depth image of the current (k) and the combined background depth image of the past (k−1) accumulated by buffering are combined, a boundary region between both depth images becomes conspicuous as the edge due to a difference in depth estimation error or a noise feeling, and this boundary region may be placed on the depth image of the final output as a linear or granular artifact. In order to prevent this phenomenon, smoothing is performed by applying a 2D filter such as a Gaussian filter, a bilateral filter, or a median filter to the depth image before buffering the combined background depth image.

Subsequently, in step S110, the combined background depth image of the current (k) is temporarily stored by buffering. The buffered combined background depth image is used as the past combined background depth image in step S107 of the processing in a next frame (k+1).

Note that, a depth image feedback loop is constituted by steps S107, S108, S109, and S110 in FIG. 3. In the combination of the background depth image in the depth image feedback loop, the current (latest) frame is preferentially left by overwriting in the order of the past frame to the current (latest) frame.

Subsequently, in step S111, foreground mask processing is performed on the color image. Although the depth image is separated into the foreground and the background in the foreground and background separation processing in step S104 described above, it is necessary to generate a color image (referred to as a background color image) of only the background from which the foreground is separated also for the color image. Therefore, first, due to the use of the foreground depth image, a region including pixels having a depth value in the foreground depth image is set as a mask used for the foreground mask processing.

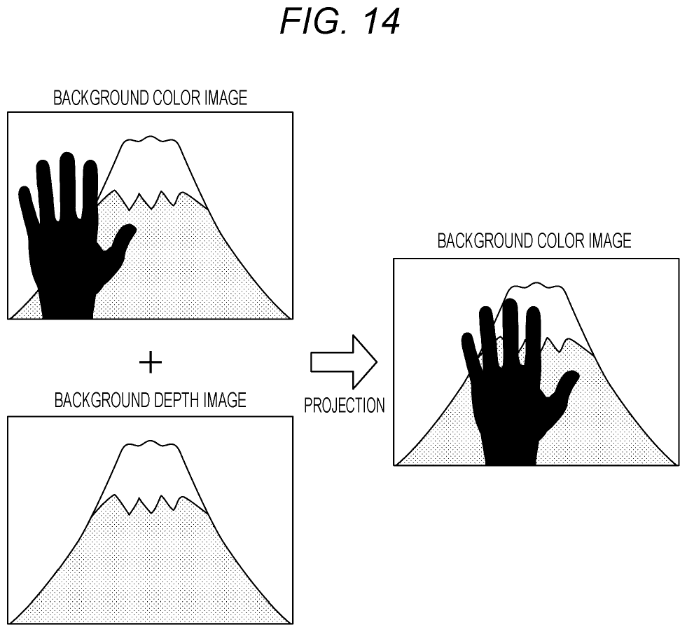

Then, as illustrated in FIG. 14, the mask is applied to the color image, and thus, the background color image of the current (k) in which only the foreground region is filled in black and is removed (color information is set to 0) and which is the color image of only the background can be generated. As a result, it is possible to determine that the region filled in black and removed is the occlusion region of the current frame, and it becomes easy to perform interpolation with the past color information in subsequent color image combination processing.

Subsequently, in step S112, the combined background depth image of the current (k) is projected. The combined background depth image of the current (k) which is at the display viewpoint is projected onto the color camera viewpoint, and thus, the depth image to be used for projecting the background color image to be described later is generated. This is because the projection of the background color image requires the depth image of the same viewpoint (color camera viewpoint) in addition to the color image.

Subsequently, in step S113, the background color image of the current (k) generated in the foreground mask processing in step S111 is projected. Since the background has the occlusion region by the foreground object, the background color image from which the foreground object is removed by the foreground mask processing is projected from the color camera viewpoint onto the display viewpoint.

Furthermore, in step S114, the combined background color image of the past (k−1) is projected. This combined background color image is generated in step S115 in the past (k−1) and is temporarily stored by buffering in step S116.

Since the display viewpoint constantly fluctuates due to fluctuation of the self-position of the user, the combined background color image of the display viewpoint of the past (k−1) temporarily stored by buffering is projected onto the display viewpoint of the current (k). Therefore, this fluctuation corresponds to fluctuation in a line-of-sight due to the self-position fluctuation of the user.

Subsequently, in step S115, the projected background color image of the current (k) and the projected combined background color image of the past (k−1) are combined to generate the combined background color image of the current (k). Note that, unlike the combination of the depth image, when a plurality of frames is easily mixed, colors of different subjects are mixed, and an artifact occurs. Accordingly, the combination of the color image needs to be performed carefully.

There are two methods for combining the color images. A first method of the color image combination is a method for determining a priority between two color images to be combined and overwriting a buffer in order from a lower priority. The current background color image is preferentially left in the final buffer by setting the priority of the current background color image to be higher than that of the past background color image and overwriting the past background color image and the current background color image in this order. Therefore, the current background color image is preferentially left, and the latest color information is easily displayed on the display 108.

A second method of the color image synthesis is a combination method using a blending. The past background color image and the current background color image are a-blended, and thus, a color denoise effect and a resolution enhancement effect can be obtained.

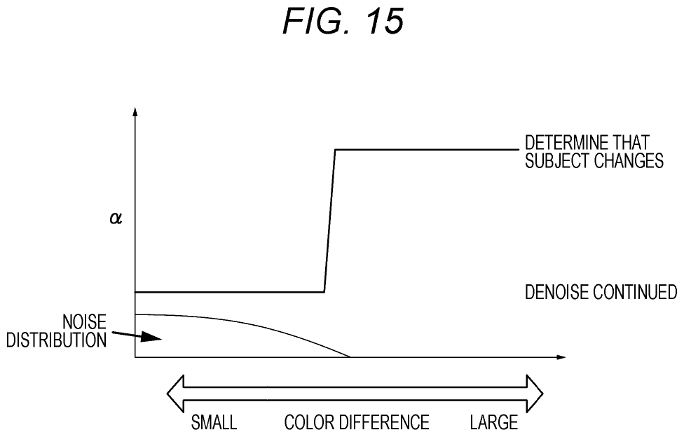

In order to prevent different subjects from being mixed in the combination of the color image, it is necessary to devise a technique of perform the combination by calculating a color difference for each pixel between the current background color image and the past background color image and setting α to an appropriate value only in a case where the color difference is small enough to fall in a noise distribution as illustrated in FIG. 15.

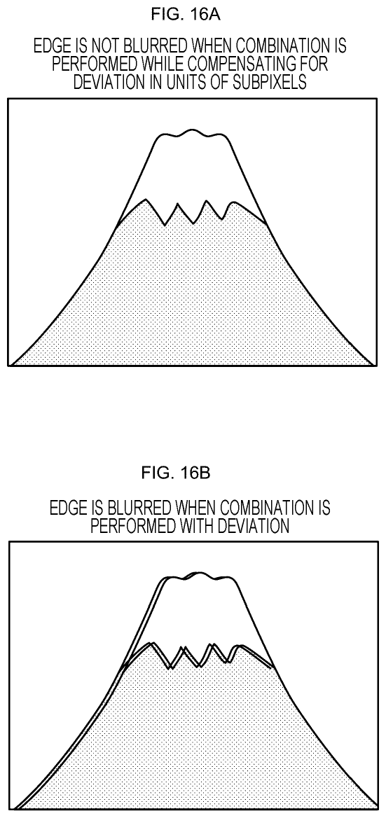

Furthermore, in a case where resolution enhancement processing by α blending is also performed, since it is necessary to perform the combination after performing precise alignment with pixel accuracy, it is necessary to perform processing of canceling pixel deviation caused by a projection error due to a self-position estimation error or a depth estimation error. For example, block matching is performed while deviating the past color image and the current color image roughly aligned by projection in XY directions little by little in units of subpixels as illustrated in FIG. 16A, and a position having a high correlation value (SAD (Sum of Absolute Difference), SSD (Sum of Squared Difference), or the like) is found. Then, the past color image and the current color image are combined by being deviated to a position with a high correlation value, and thus, it is possible to obtain a combined color image without blurring. On the other hand, when the past color image and the current color image are combined without being deviated to the position with a high correlation value, as illustrated in FIG. 16B, the edge of the subject in the combined color image is blurred due to the deviation.

Note that, the past combined background color image and the current background color image may be combined by either the first method or the second method.

Subsequently, in step S116, the combined background color image of the current (k) is temporarily stored by buffering. The buffered combined background color image is used as the past combined background color image in step S114 of the processing in the next frame (k+1).

Note that, a color image feedback loop is constituted by steps S114, S115, and S116 in FIG. 3. In the combination of the color image in the color image feedback loop, the current (latest) frame is preferentially left by overwriting in the order of the past frame to the current (latest) frame. The latest color information is easily displayed on the display 108.

Subsequently, in step S117, the foreground color image of the current (k) and the combined background color image of the current (k) are combined to generate the output color image. The foreground color image and the combined background color image are combined by the first method for the color image combination described above. The first method is a method for determining a priority between two color images to be combined and overwriting the buffer in order from a lower priority. The foreground color image is preferentially left in the final buffer by setting the priority of the foreground color image to be higher than that of the background color image and overwriting the background color image and the foreground color image in this order.

Then, in step S118, the output color image is output. Note that, the output may be an output for display on the display 108 or an output for performing another processing on the output color image.

Subsequently, in step S119, it is confirmed whether or not the processing is ended. A case where the processing is ended is, for example, a case where the display of the image in the HMD 100 is ended.

In a case where the processing is not ended, the processing proceeds to step S120 (No in step S119). Then, in step S120, the value of k is incremented. Then, the processing returns to step S102, and steps S102 to S120 are performed on the next frame.

Then, steps S102 to S120 are repeatedly performed for each frame until the processing is ended in step S119 (Yes in step S119).

As described above, the processing by the information processing device 200 according to the first embodiment is performed. According to the first embodiment, the depth estimation is performed in each frame by a depth estimation algorithm of one shot with a low processing load, and processing of feeding back the past depth image while compensating for posture changes of the HMD 100 and the color camera 101 due to the fluctuation in the self-position and combining the past depth image with the current (latest) depth image is repeated. Therefore, geometry of an environment viewed from the position of the eyes of the user is estimated.

Moreover, in order to cope with an object that causes a large occlusion region in the background, such as a hand of the user or an object held by the hand, adaptive separation of the foreground and the background is performed, and environment geometry information of only the background is updated. Therefore, even in an occlusion region in which the depth and color of the background cannot be acquired due to the foreground object when only the current frame is viewed, compensation is performed with information of the past frame, and thus, it is possible to continue to estimate the depth and color of the occlusion region. Accordingly, it is possible to compensate for the occlusion region generated by the viewpoint transformation or the change in the viewpoint of the user.

In the processing of the first embodiment, the image is separated into the foreground and the background, and different types of processing are performed on the foreground and the background. In the foreground, real-time followability to motion of a moving object or the head of the user wearing the HMD 100 is emphasized. Therefore, the color image is not only projected from the color camera viewpoint onto the display viewpoint, but also has a simple configuration.

On the other hand, in the background, the compensation for an occlusion region generated by an object (shielding object) present in the foreground is emphasized. In order to compensate for the occlusion region, not only the latest frame but also the information of the past frame in which the shielding object is not present in the foreground is captured in the current frame. Specifically, the depth image feedback loop is constituted, and a current background depth image with less occlusion is estimated by mixing the past and current depth images with only one buffer.

Furthermore, similarly to the processing of the depth image in the feedback loop, in the background, the processing is also performed on the color image in the feedback loop, and the current background color image with less occlusion is estimated from the past and current color images in one buffer. The past and current color images are combined, and thus, the denoise and resolution enhancement effects can also be expected.

Due to the separation of the foreground and the background, it is possible to perform the compensation including the occlusion region generated in a case where there is the motion of the head of the user or the motion of the object in the foreground which has been a problem in the technology of the related art while a calculation amount is small in two-dimensional image processing. Furthermore, it is also possible to implement that processing policy is changed in such a manner that a high real-time property is emphasized for the foreground and stability is emphasized for the background.

Furthermore, in the combination of the past and current depth images, it is also possible to adjust responsiveness to a change in depth information of the environment and stability against noise by adaptively changing an α value of the α blending in accordance with the depth value and the reliability of the depth value.

Note that, in the present technology, the numbers of color cameras 101, distance measuring sensors 102, and displays 108 are not limited. The present technology is also applicable to a case where the numbers of color cameras 101, distance measuring sensors 102, and displays 108 are 1 to n in a generalized manner.

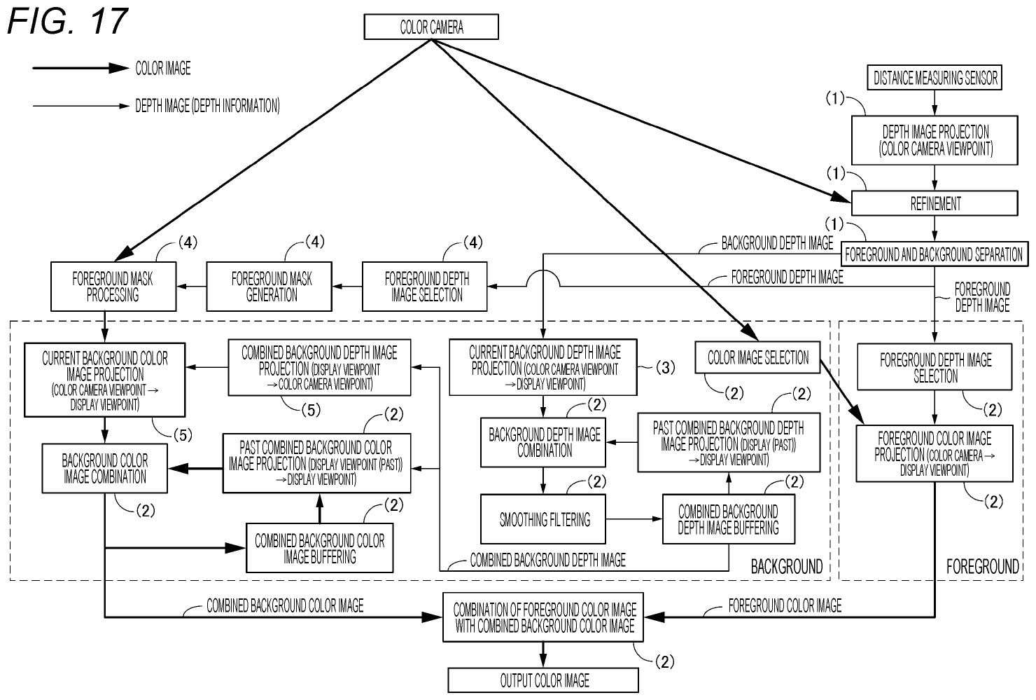

FIG. 17 illustrates a processing block diagram of the generalized information processing device 200. Reference signs (1), (2), (3), (4), and (5) attached to blocks are obtained by classifying how the numbers of blocks are determined by the number of color cameras 101, the number of distance measuring sensors 102, and the number of displays 108.

The number of blocks to which (1) is attached is determined by “number of color cameras 101×number of distance measuring sensors 102”. The number of blocks to which (2) is attached is determined by “number of displays 108”. The number of blocks to which (3) is attached is determined by “number of color cameras 101×number of distance measuring sensors 102×number of displays 108”. The number of blocks to which (4) is attached is determined by “number of color cameras 101”. Moreover, the number of blocks to which (5) is attached is determined by “number of color cameras 101×number of displays 108”.

Note that, as a method for selecting images in a selection block of the foreground depth image and a selection block of the color image in the information processing device 200 illustrated in FIG. 17, there are methods for selecting an image obtained by a camera (sensor) closest to the display viewpoint, selecting an image with the least noise, and the like.

In the combination of the depth image by the information processing device 200 illustrated in FIG. 17, it is considered that all depth images to be input are combined by α blending. In this case, a term such as “closeness to the display viewpoint” may be added to the calculation for determining the value of α. By doing so, an input closer to the display viewpoint is more frequently used.

Furthermore, in a case where the first method for the color image combination is executed by the information processing device 200 illustrated in FIG. 17, a priority may be determined on the basis of “closeness to the display viewpoint”, and color overwriting may be performed in from a lower priority (priority is given in the order of the current frame (close to display)>current frame (far from display)>past frame). Note that, in a case where the combination of the color images in the information processing device 200 illustrated in FIG. 17 is performed by the second method (a blending), the combining is similar to the combination of the depth images.

### 2. Second Embodiment

### [2-1. Processing by Information Processing Device 200]

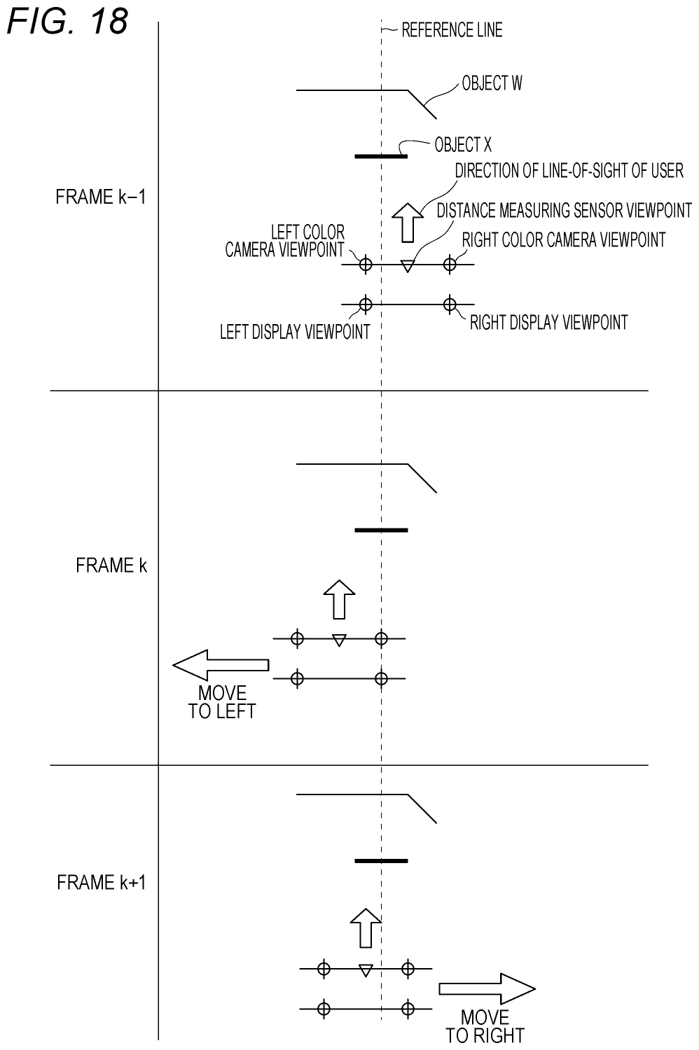

Next, a second embodiment of the present technology will be described with reference to FIGS. 18 to 22. A configuration of an HMD 100 is similar to that in the first embodiment.

As illustrated in FIG. 18, the second embodiment illustrates a disposition in which viewpoints (color camera viewpoints) of two color cameras 101 included in the HMD 100 and a viewpoint (distance measuring sensor viewpoint) of one distance measuring sensor 102 are present in front of a display viewpoint (right display viewpoint and left display viewpoint), which is a virtual viewpoint corresponding to a viewpoint of a user.

Furthermore, as illustrated in FIG. 18, a case where an object X (for example, a television) and an indoor wall (object W) behind the object X are present in front of the user will be described as an example.

Moreover, as illustrated in FIG. 18, a case where self-position of the user wearing the HMD 100 moves to the left from a state of a frame k−1 in a frame k and moves to the right from the state of the frame k in a frame k+1 will be described as an example. The viewpoint of the user changes due to fluctuation in the self-position of the user. An occlusion region is generated in an image due to a change in the viewpoint of the user. Note that, a reference line in FIG. 18 is drawn along a center of the object X for easy understanding of the movement of the self-position of the user.

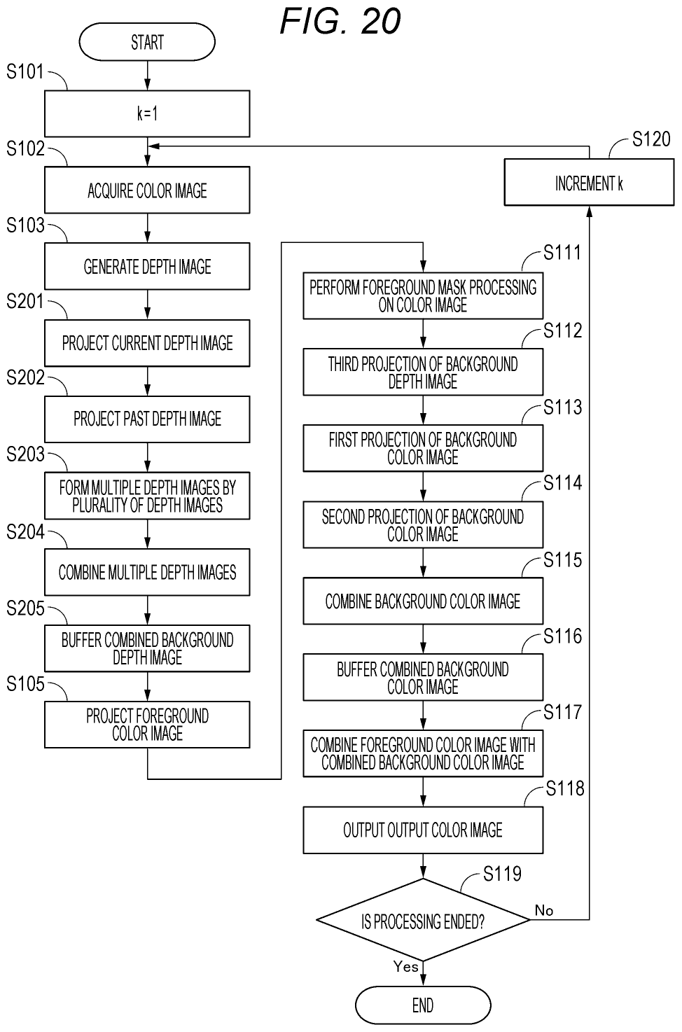

Processing illustrated in the flowchart of FIG. 20 is performed on each frame constituting a video. Note that, steps S101 to S103 are similar to those in the first embodiment.

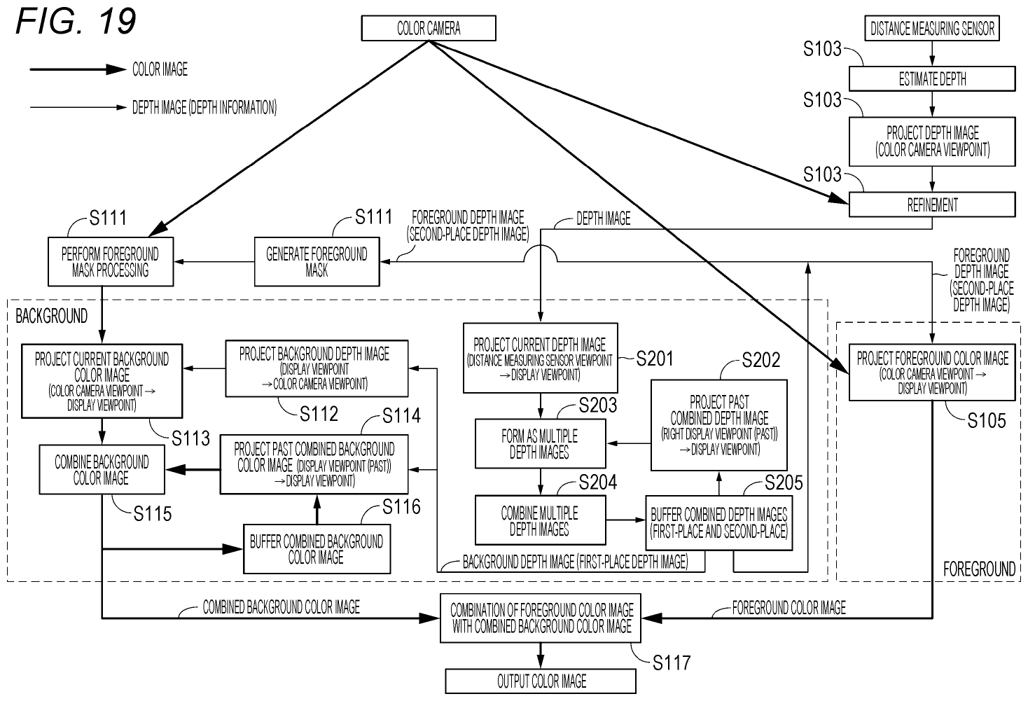

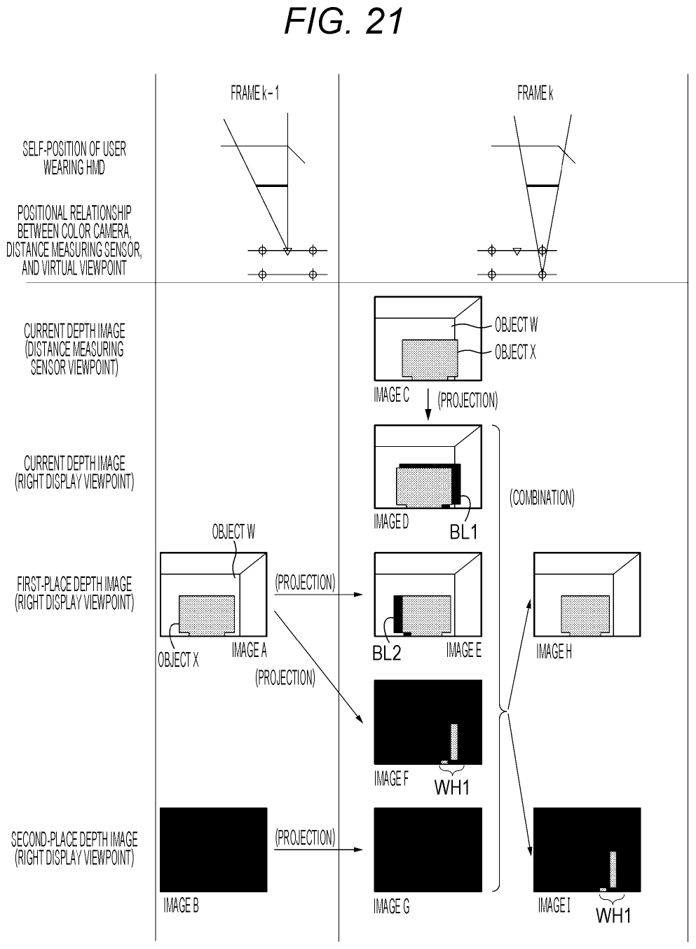

First, processing at current (k) will be described with reference to FIGS. 19, 20, and 21. In the description of FIG. 21, a frame k is “current”, and a frame immediately before the frame k, that is, a frame k−1 is “past”.

Note that a first-place depth image A and a second-place depth image B, which are combined depth images, are generated in the processing in the past (k−1) and are already temporarily stored by buffering in the processing in step S205. Although details of the first-place depth image and the second-place depth image will be described later, these images are generated by combining depth images, and are obtained by multiplexing and retaining depth information in the past.

Steps S201 to S205 in the second embodiment will be described on the assumption that the virtual viewpoint is the display viewpoint. The display includes a left display for a left eye and a right display for a right eye. A position of the left display may be considered to be the same as a position of the left eye of the user. Thus, a left display viewpoint is a left eye viewpoint of the user. Furthermore, a position of the right display may be considered to be the same as a position of the right eye of the user. Thus, a right display viewpoint is a right eye viewpoint of the user. When viewpoint transformation is performed to project the depth image of the distance measuring sensor viewpoint onto the right display viewpoint, which is the virtual viewpoint, to obtain an image of the right display viewpoint, the occlusion region is generated. Similarly, when viewpoint transformation is performed to project the depth image of the distance measuring sensor viewpoint onto the left display viewpoint, which is the virtual viewpoint, to obtain an image of the left display viewpoint, the occlusion region is generated.

A depth image of the current (k) generated in step S103 on the basis of a latest distance measurement result acquired by the distance measuring sensor 102 is projected onto the virtual viewpoint in step S201. As described above, the virtual viewpoints are the left and right display viewpoints, and a depth image C of the current (k) is projected onto the display viewpoint. In the following description, the virtual viewpoint is defined as the right display viewpoint, and projection onto the right display viewpoint which is one of the left and right display viewpoints is performed as illustrated in FIG. 21. The projection result is referred to as a depth image D.

Since the distance measuring sensor viewpoint and the display viewpoint are not at the same position and the right display viewpoint is on a right side of the distance measuring sensor 102, when the depth image C of the distance measuring sensor viewpoint is projected onto the right display viewpoint, as illustrated in the depth image D, the object X appears to move to the left. Moreover, since the distance measuring sensor viewpoint and the right display viewpoint have different front and rear positions, when the depth image C of the distance measuring sensor viewpoint is projected onto the right display viewpoint, the object X looks small. As a result, in the depth image D, an occlusion region BL1 (filled in black in FIG. 21) having no depth information appears since the region is hidden by the object X in the depth image C.

Furthermore, in step S202, the first-place depth image A and the second-place depth image B, which are combined depth images of the past (k−1) and are temporarily stored by buffering, are projected onto a right display viewpoint of the current (k) in consideration of the movement of the viewpoint due to the fluctuation in the self-position of the user.

The results of projecting the first-place depth image A of the past (k−1) onto the right display viewpoint of the current (k) are a depth image E and a depth image F illustrated in FIG. 21. In a case where the self-position of the user moves to the left from the past (k−1) to the current (k), the user sees as if the object X in front moves to the right. Then, as illustrated in the depth image E, an occlusion region BL2 (filled in black in FIG. 21) having no depth information appears since the region is hidden by the object X in the past (k−1).

Furthermore, in a case where the self-position of the user moves to the left from the past (k−1) to the current (k), the user sees as if the object X in front moves to the right. At a point in time of the past (k−1), a partial region of the object W visible in the first-place depth image A (having depth information) is shielded by a part of the object X. A partial region of the object X to be shielded is set as WH1 of the image F. However, a depth value of the object W which is a side shielded as the image E is continuously retained. Even at the current (k), the depth information of the object W shielded by the region WH1 present at the point in time of the past (k−1) is continuously retained. Therefore, even at the current (k), the depth information of the region of the object W shielded by the region WH1 can be handled as being present. Note that, the depth image F is an image having no depth value other than the region WH1.

Moreover, as a result of projecting the past (k−1) second-place depth image B onto the right display viewpoint of the current (k), a depth image G is generated. In a case where the second-place depth image B has no depth information, the depth image G is also an image having no depth information.

In the second embodiment, for all pixels having effective depth values, depth images are individually projected to the first-place depth image and the second-place depth image which are the combined depth images and are multiplexed and retained such that depth information of a depth image of a projection source is not lost by integrating a plurality of depth images by projection.

In the related art, as the projection result, in a case where pixels of the depth image of the projection source have different pixel values are projected onto the same pixel position in a projection destination, only the depth value coming to a near side is retained for the pixel. On the other hand, in the second embodiment, a depth value that is on a far side and is shielded is also retained as the first-place depth image, and a depth image that is on a near side and is shielded is also retained as the second-place depth image.

Subsequently, in step S203, the depth image D projected in step S201, the depth image E, the depth image F, and the depth image G projected in step S202 are collectively formed as multiple depth images at the current (k).

Subsequently, in step S204, all the multiple depth images are combined to generate a first-place depth image and a second-place depth image at the current (k) as new combined depth images. At this time, the depth image D, which is a result of projecting a latest distance measurement result obtained at the current (k) onto the right display viewpoint, is also a target of combination processing.

In the combination processing, first, a first-place depth image H at the current (k) is generated by forming one image with pixels having a maximum depth value and the same depth value among all the pixels in all the multiple depth images to be combined. A region having no depth information such as the occlusion region BL2 is present in the depth image E, but the depth information of the occlusion region BL2 can be compensated by the depth information of the depth image D. Therefore, the first-place depth image H at the current (k) in which the depth information is not missing can be generated.

Furthermore, in the combination processing, a second-place depth image I at the current (k) is generated by forming one image with pixels having a second largest depth value and the same depth value among all the pixels in all the multiple depth images to be combined. The second-place depth image is an image that retains depth information not included in the first-place depth image, and retains depth information of the region WH1 not included in the first-place depth image H. Note that, the second-place depth image I is an image having no depth information other than the region WH1.

Note that, in the present embodiment, although the first-place depth image is generated by collecting pixels having a maximum pixel value and the second-place depth image is generated by collecting pixels having a second largest pixel value, the number of combined depth images to be generated is not limited to two. Any number of n-th-place depth images may be generated by collecting n-th depth values having third and subsequent pixel value sizes. For example, in a case where objects are present in three layers such as a vase, an object X at the back of the vase, and an object W at the back of the object X, a third-place depth image is generated. Up to which depth value depth images are generated is set in advance for the information processing device 200.

Furthermore, in the same value determination as to whether “the pixels have the same depth value” when the depth images are combined, the same value may be regarded as within a certain margin. Furthermore, a value of the margin may be changed depending on the distance. For example, since a distance measurement error is larger as the distance is longer, the margin of the same value determination is increased.

Subsequently, in step S205, the first-place depth image H and the second-place depth image I, which are combined depth images, are temporarily stored by buffering.

Subsequent processing is performed by setting the second-place depth image I generated in this manner as a foreground depth image similar to that in the first embodiment and setting the first-place depth image H as a background depth image similar to that in the first embodiment. The foreground depth image is used for the projection of the foreground color image in step S105 and the generation of the foreground mask in step S111. Furthermore, the background depth image is used for the projection of the background depth image in step S112.

The subsequent processing from step S105, and step S111 to step S120 is similar to that in the first embodiment.

As described above, in the second embodiment, the depth information retained in one depth image is multiplexed and retained in the form of a plurality of depth images such as the first-place depth image and the second-place depth image in the related art. Therefore, the depth information present in the past is not lost.

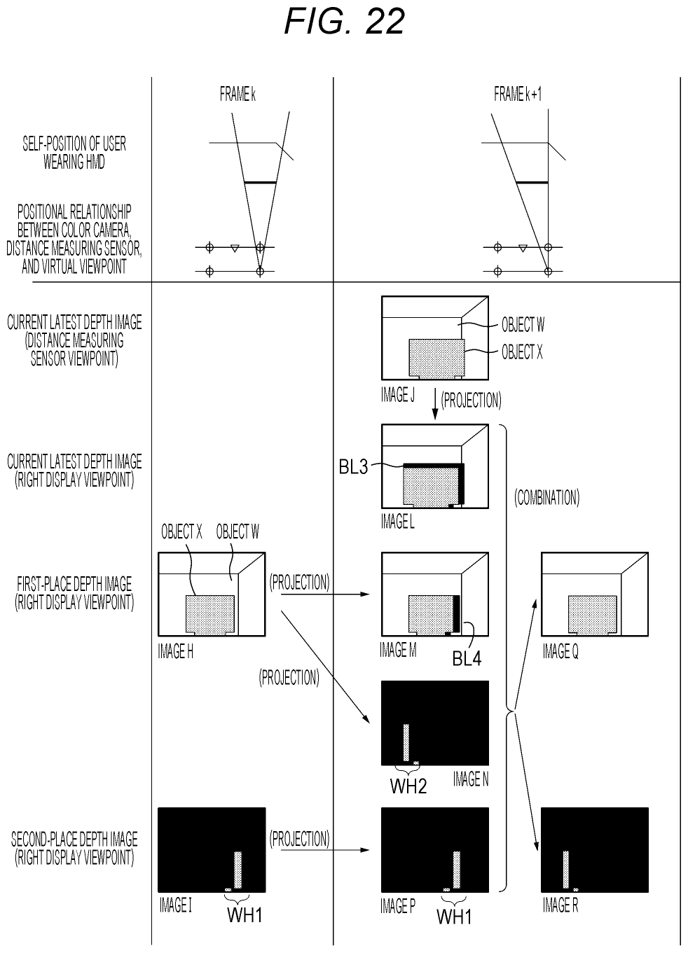

Next, processing in the frame k+1 will be described with reference to FIGS. 19, 20, and 22. In the description of FIG. 22, the frame proceeds one frame from the state of FIG. 21, and the frame k+1 is set to “current”, and a previous frame of the frame k+1, that is, the frame k is set to “past”. Furthermore, as illustrated in FIG. 18, the description will be given on the assumption that the self-position of the user wearing the HMD 100 moves to the right from the state of the frame k in the frame k+1.

Note that the first-place depth image H and the second-place depth image I are generated in the processing in the past (k) and are temporarily stored by buffering in the processing of step S205. In the first-place depth image H, it is assumed that there are depth values in all pixels, that is, there is no region where depth information is not present.

After the depth image of the current (k+1) generated in step S103 on the basis of the latest distance measurement result acquired by the distance measuring sensor 102 is separated as a depth image J of the current (k+1) in step S104, the processing of the second embodiment is performed. In step S201, the depth image J of the current (k+1), which is the latest distance measurement result acquired by the distance measuring sensor 102, is projected onto the right display viewpoint. The projection result is a depth image L.

Since the distance measuring sensor 102 and the right display viewpoint are not at the same position and the right display viewpoint is on the right side of the distance measuring sensor 102, when the depth image J of the distance measuring sensor viewpoint is projected onto the right display viewpoint, as shown in the depth image L, the object X appears to move to the left. Moreover, since the distance measuring sensor viewpoint and the right display viewpoint have different front and rear positions, when the depth image J of the distance measuring sensor viewpoint is projected onto the right display viewpoint, the object X looks small. As a result, in the depth image L, an occlusion region BL3 having no depth information appears since the region is hidden by the object X in the depth image J.

Furthermore, in step S202, the first-place depth image H and the second-place depth image I, which are combined depth images of the past (k) and are temporarily stored by buffering, are projected onto a right display viewpoint of the current (k+1) in consideration of the movement of the viewpoint due to the fluctuation in the self-position of the user.

The results of projecting the first-place depth image H of the past (k) onto the right display viewpoint of the current (k+1) are a depth image M and a depth image N. In a case where the self-position of the user moves to the right from the past (k) to the current (k+1), the user sees as if the object X moves to the left. Then, as illustrated in the depth image M, an occlusion region BL4 having no depth information appears since the region is hidden by the object X in the past (k).

In a case where the self-position of the user moves to the right from the past (k) to the current (k+1), the user sees as if the object X in front moves to the left. At a point in time of the past (k), a partial region of the object W visible in the first-place depth image H (having depth information) is shielded by a part of the object X. A partial region of the object X to be shielded is set as WH2 of the image N. However, a depth value of the object W which is a side shielded as the image M is continuously retained. Even at the current (k+1), the depth information of the object W shielded by the region WH2 present at the point in time of the past (k) is continuously retained. Therefore, even at the current (k+1), the depth information of the region of the object W shielded by the region WH2 can be handled as being present.

Moreover, as a result of projecting the past (k) second-place depth image I onto the right display viewpoint at the current (k+1), a depth image P is generated. Since the second-place depth image I in the past (k) includes the depth information of the region WH1, the depth image P also includes the depth information of the region WH1.

In the second embodiment, for all pixels having effective depth values, depth images are individually projected to the first-place depth image and the second-place depth image which are the combined depth images and are multiplexed and retained such that depth information of a depth image of a projection source is not lost by integrating a plurality of depth images by projection. This is similar to the case of the frame k described with reference to FIG. 21.

Subsequently, in step S203, the depth image L projected in step S201, the depth image M, the depth image N, and the depth image P projected in step S202 are collectively set as multiple depth images at the current (k+1).

Subsequently, in step S204, all the multiple depth images are combined to generate a first-place depth image and a second-place depth image at the current (k+1) as new depth images. At this time, the depth image L, which is a result of projecting a latest distance measurement result obtained at the current time (k+1) onto the right display viewpoint, is also a target of the combination processing.

In the combination processing, first, a first-place depth image Q at the current (k+1) is generated by forming one image with pixels having a maximum depth value and the same depth value among all the pixels in all the multiple depth images to be combined. A region having no depth information such as the occlusion region BL4 is present in the depth image M, but the depth information of the occlusion region BL4 can be compensated by the depth information of the depth image P. Therefore, the first-place depth image Q at the current (k+1) where the depth information is not missing can be generated.

Furthermore, in the combination processing, a second-place depth image R at the current (k+1) is generated by forming one image with pixels having a second largest depth value and the same depth value among all the pixels in all the multiple depth images to be combined. The second-place depth image is an image that retains depth information not included in the first-place depth image, and the second-place depth image R retains depth information in the region WH2. Note that, the second-place depth image R is an image having no depth information other than WH2. A method for generating the first-place depth image and the second-place depth image is similar to the method described in the case where the frame k is the current frame.

Subsequently, in step S205, the first-place depth image Q and the second-place depth image R, which are combined depth images at the current (k+1), are temporarily stored by buffering. Subsequent processing is performed by setting the second-place depth image R generated in this manner as a foreground depth image similar to that in the first embodiment and setting the first-place depth image Q as a background depth image similar to that in the first embodiment.

The subsequent processing from step S111 to step S120 is similar to that in the first embodiment.

As described above, in the second embodiment, the depth information retained in one depth image is multiplexed and retained in the form of a plurality of depth images such as the first-place depth image and the second-place depth image in the related art. Therefore, it is possible to continue to retain the depth information present in the past frame without losing the depth information, and even though the occlusion region is generated due to the viewpoint transformation or the fluctuation in the self-position of the user, the occlusion region can be compensated with the depth information being continued to be retained.

Note that, in FIGS. 21 and 22, for the depth image obtained by the distance measuring sensor 102, the first-place depth image and the second-place depth image may also be generated, and the depth information may be multiplexed and retained. In this case, types of processing after the combination are similarly performed.

As described above, the processing by the information processing device 200 according to the second embodiment is performed. According to the second embodiment, the depth estimation is performed in each frame by a depth estimation algorithm of one shot with a low processing load, and the geometry of the environment viewed from the position of the eyes of the user is estimated by repeating the processing of feeding back the past depth image and combining the past depth image with the current (latest) depth image while compensating for the posture changes of the HMD and the camera.

When the depth image obtained in the past and the current (latest) depth image are combined, a region (pixel) in which the depth value is multi-valued is generated. In general, for these pixels, it is usual to adopt only a value that is the forefront (the depth value is a smallest value) and retain the value by buffering. In the second embodiment, the above processing is not performed, and multi-valued depth values are retained by buffering. By doing so, it is possible to prevent early disappearance of the depth information at the past point in time, and it is possible to prevent re-occurrence of a blind spot in a case where the head of the user moves.

Since both the first embodiment and the second embodiment of the present technology perform processing using two-dimensional information of the color image and the depth image, there is an advantage that processing is lighter and faster than a technology using voxels (three-dimensional) while retaining full resolution information of a viewpoint transformation destination. Furthermore, there is also an advantage that it is easy to apply the filter processing using OpenCV or the like in the case of processing for the buffered two-dimensional depth image.

Note that, in the second embodiment, although it has been described that the virtual viewpoint is the right display viewpoint, the virtual viewpoint is not limited to the right display viewpoint, and may be the left display viewpoint or a viewpoint at another position.

Although FIG. 17 illustrates the information processing device 200 according to the first embodiment in which the numbers of color cameras 101, distance measuring sensors 102, and displays 108 are not limited and are generalized, the information processing device 200 according to the second embodiment can also be generalized similarly without limiting the numbers of color cameras 101, distance measuring sensors 102, and displays 108.

### 3. Modifications

Although the embodiment of the present technology has been specifically described above, the present technology is not limited to the above-described embodiment, and various modifications based on the technical idea of the present technology are possible.

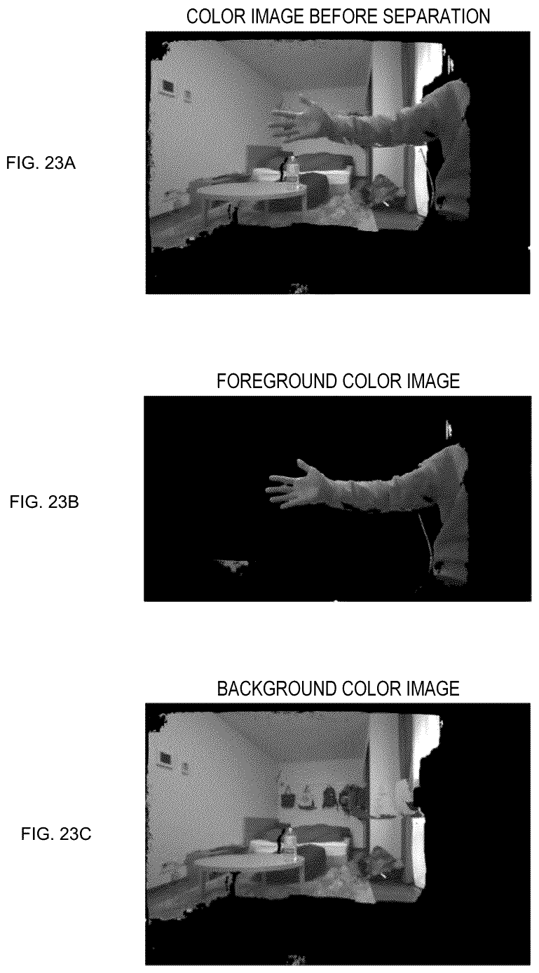

The foreground and background separation processing can be used in addition to the occlusion compensation at the time of the viewpoint transformation described in the embodiments. In the example illustrated in FIG. 23, a color image before separation illustrated in FIG. 23A is separated into a foreground color image illustrated in FIG. 23B and a background color image illustrated in FIG. 23C. By using this, for example, it is possible to implement an application of “removing the hand or the like of the user from the VST experience in the real space”, an application of “drawing only the body of the user in the virtual space”, or the like by drawing only one of the separated foreground and background.

The present technology can also have the following configurations.

(1) An information processing device configured to:
acquire a color image at a first viewpoint and a depth image at a second viewpoint; and
generate an output color image at a virtual viewpoint different from the first viewpoint on a basis of a result of separation processing of separating the depth image into a foreground depth image and a background depth image.

(2) The information processing device according to (1), in which first processing is performed on the foreground depth image, and second processing is performed on the background depth image.

(3) The information processing device according to (2), in which, in the second processing, a current background depth image projected onto the virtual viewpoint and a past background depth image projected onto the virtual viewpoint are combined to generate a combined background depth image at the virtual viewpoint.

(4) The information processing device according to any one of (1) to (3), in which a background color image obtained by removing a region including pixels in which depth values are present on the foreground depth image from the color image is generated.

(5) The information processing device according to (4), in which the background color image projected onto the virtual viewpoint and the past background color image projected onto the virtual viewpoint are combined to generate a combined background color image at the virtual viewpoint.

(6) The information processing device according to (5), in which the output color image is generated by combining a foreground color image obtained by projecting the color image onto the virtual viewpoint with the combined background color image.

(7) The information processing device according to any one of (1) to (6), in which, in the separation processing, a fixed threshold for a depth value is set, and the input depth image is separated into the foreground depth image and the background depth image on a basis of a comparison result of the depth value with the threshold.

(8) The information processing device according to any one of (1) to (6), in which, in the separation processing, a dynamic threshold for a depth value is set, and the input depth image is separated into the foreground depth image and the background depth image on a basis of a comparison result of the depth value with the threshold.

(9) The information processing device according to any one of (1) to (6), in which, in the separation processing, the past depth information is multiplied in multiple depth images including a plurality of depth images and is retained, and the multiple depth images projected onto the virtual viewpoint are combined to generate a combined depth image.

(10) The information processing device according to (9), in which a first-place depth image which is the combined depth image is generated by constituting an image by pixels having a maximum depth value and the same depth value on the multiple depth images, and the depth image is separated by using the first-place depth image as the background depth image.

(11) The information processing device according to (9) or (10), in which a second-place depth image which is the combined depth image is generated by constituting an image by pixels having a second largest depth value and having the same depth value on the multiple depth images projected onto the virtual viewpoint, and the depth image is separated by using the second-place depth image as the foreground depth image.

(12) The information processing device according to any one of (1) to (11), in which the virtual viewpoint is a viewpoint corresponding to a display included in a head mount display.

(13) The information processing device according to any one of (1) to (12), in which the virtual viewpoint is a viewpoint corresponding to an eye of a user wearing a head mount display.

(14) The information processing device according to any one of (1) to (13), in which the first viewpoint is a viewpoint of a color camera that images the color image.

(15) The information processing device according to (3), in which smoothing filter processing is performed on the combined background depth image.

(16) The information processing device according to (2), in which the second processing has more processing steps than the first processing.

(17) An information processing method including:
acquiring a color image at a first viewpoint and a depth image at a second viewpoint; and
generating an output color image at a virtual viewpoint different from the first viewpoint on a basis of a result of separation processing of separating the depth image into a foreground depth image and a background depth image.

(18) A program causes a computer to execute an information processing method of:
acquiring a color image at a first viewpoint and a depth image at a second viewpoint; and
generating an output color image at a virtual viewpoint different from the first viewpoint on a basis of a result of separation processing of separating the depth image into a foreground depth image and a background depth image.

### REFERENCE SIGNS LIST

100 Head mounted display (HMD)
200 Information processing device

1. An information processing device configured to:
acquire a color image at a first viewpoint and a depth image at a second viewpoint; and
generate an output color image at a virtual viewpoint different from the first viewpoint on a basis of a result of separation processing of separating the depth image into a foreground depth image and a background depth image.

2. The information processing device according to claim 1, wherein
first processing is performed on the foreground depth image, and second processing is performed on the background depth image.

3. The information processing device according to claim 2, wherein,
in the second processing, a current background depth image projected onto the virtual viewpoint and a past background depth image projected onto the virtual viewpoint are combined to generate a combined background depth image at the virtual viewpoint.

4. The information processing device according to claim 1, wherein
a background color image obtained by removing a region including pixels in which depth values are present on the foreground depth image from the color image is generated.

5. The information processing device according to claim 4, wherein
the background color image projected onto the virtual viewpoint and the past background color image projected onto the virtual viewpoint are combined to generate a combined background color image at the virtual viewpoint.

6. The information processing device according to claim 5, wherein
the output color image is generated by combining a foreground color image obtained by projecting the color image onto the virtual viewpoint with the combined background color image.

7. The information processing device according to claim 1, wherein,
in the separation processing, a fixed threshold for a depth value is set, and the input depth image is separated into the foreground depth image and the background depth image on a basis of a comparison result of the depth value with the threshold.

8. The information processing device according to claim 1, wherein,
in the separation processing, a dynamic threshold for a depth value is set, and the input depth image is separated into the foreground depth image and the background depth image on a basis of a comparison result of the depth value with the threshold.

9. The information processing device according to claim 1, wherein,
in the separation processing, the past depth information is multiplied in multiple depth images including a plurality of depth images and is retained, and the multiple depth images projected onto the virtual viewpoint are combined to generate a combined depth image.

10. The information processing device according to claim 9, wherein
a first-place depth image which is the combined depth image is generated by constituting an image by pixels having a maximum depth value and the same depth value on the multiple depth images, and the depth image is separated by using the first-place depth image as the background depth image.

11. The information processing device according to claim 9, wherein
a second-place depth image which is the combined depth image is generated by constituting an image by pixels having a second largest depth value and having the same depth value on the multiple depth images projected onto the virtual viewpoint, and the depth image is separated by using the second-place depth image as the foreground depth image.

12. The information processing device according to claim 1, wherein
the virtual viewpoint is a viewpoint corresponding to a display included in a head mount display.

13. The information processing device according to claim 1, wherein
the virtual viewpoint is a viewpoint corresponding to an eye of a user wearing a head mount display.

14. The information processing device according to claim 1, wherein
the first viewpoint is a viewpoint of a color camera that images the color image.

15. The information processing device according to claim 3, wherein
smoothing filter processing is performed on the combined background depth image.

16. The information processing device according to claim 2, wherein
the second processing has more processing steps than the first processing.

17. An information processing method comprising:
acquiring a color image at a first viewpoint and a depth image at a second viewpoint; and
generating an output color image at a virtual viewpoint different from the first viewpoint on a basis of a result of separation processing of separating the depth image into a foreground depth image and a background depth image.

18. A program causing a computer to execute an information processing method of:
acquiring a color image at a first viewpoint and a depth image at a second viewpoint; and
generating an output color image at a virtual viewpoint different from the first viewpoint on a basis of a result of separation processing of separating the depth image into a foreground depth image and a background depth image.
